(19) United States
(12) Patent Application Publication
(10) Pub. No.: US 2026/0184561 A1
(43) Pub. Date: Jul. 2, 2026

(54) MEMBRANE REACTOR FOR HYDROGEN PRODUCTION FROM HYDROGEN SULFIDE

(71) Applicant: Saudi Arabian Oil Company, Dhahran (SA)

(72) Inventors: Hassan A. Aljama, Al Qatif (SA); Stephen N. Paglieri, Dhahran (SA); Ameen Alabdulaal, Dhahran (SA); Guanghui Zhu, Dhahran (SA); Zainab Alaithan, Dammam (SA)

(21) Appl. No.: 19/008,168

(22) Filed: Jan. 2, 2025

(51) Int. Cl. C01B 3/04

(52) U.S. Cl. CPC C01B 3/04; C01B 2203/0277; C01B 2203/0883; C01B 2203/1011; C01B 2203/1041; C01B 2203/1205

(57) ABSTRACT

Methods and systems for converting hydrogen sulfide (H₂S) to hydrogen (H₂) and sulfur (S). The method includes passing a H₂S-containing feed gas stream through one or more membrane reactors to contact the H₂S-containing feed gas stream with a H₂S decomposition catalyst of a hydrogen-permeable membrane, thereby converting at least a portion of the H₂S to H₂ and S and producing a spent catalyst in-situ, a H₂ permeate gas stream, and a retentate gas stream. The hydrogen-permeable membrane allows only H₂ to pass through in the formation of the H₂ permeate gas stream. The S is present in the retentate gas stream in the form of a vapor.

### TECHNICAL FIELD

The present disclosure relates to a hydrogen sulfide splitting method, more particularly, to a method for converting hydrogen sulfide to hydrogen and sulfur in membrane reactors. The present disclosure also provides membrane reactors containing hydrogen-permeable membranes, more particularly, to metallic membrane reactors containing hydrogen-permeable membranes for simultaneous hydrogen sulfide splitting and hydrogen separation from a hydrogen sulfide containing feed gas stream.

### BACKGROUND

The production of hydrogen (H₂) from hydrogen sulfide (H₂S) represents an opportunity to convert an environmentally harmful and hazardous material into a beneficial commodity. H₂S, known for its toxic nature, can have detrimental effects on both human health and the integrity of equipment and infrastructure in the oil and gas industry. H₂S is typically treated in oil and gas processing facilities using sulfur recovery units (SRU), such as the Claus process. In sulfur recovery units, H₂S first undergoes a thermal process that partially converts it into sulfur dioxide (SO₂) and elemental sulfur. This is followed by catalytic reactions where SO₂ reacts with the remaining H₂S to produce additional sulfur and water.

Recovering H₂ from H₂S offers sustainability improvements, considering the importance of H₂ and its low carbon footprint. Processes, including partial oxidation, reformation, thermochemical, thermo-catalytical, and photocatalytic decomposition, have been explored in the field of H₂S conversion. However, these processes still suffer from limited H₂ yield and complex process requirements. Accordingly, there is a need to develop an efficient H₂S splitting process to overcome the above-mentioned challenges.

### SUMMARY

In an exemplary embodiment, a method for converting hydrogen sulfide (H₂S) to hydrogen (H₂) and sulfur (S) includes introducing a H₂S-containing feed gas stream into one or more membrane reactors. In some embodiments, each of the one or more membrane reactors includes a hydrogen-permeable membrane in a multi-layered structure containing a metallic layer, a protective layer disposed on the metallic layer, and one or more catalyst layers disposed on the protective layer. In some embodiments, each of the one or more catalyst layers comprises a H₂S decomposition catalyst. The method further includes passing the H₂S-containing feed gas stream through the one or more membrane reactors to contact the H₂S-containing feed gas stream with the H₂S decomposition catalyst of the hydrogen-permeable membrane, thereby converting at least a portion of the H₂S to H₂ and S and producing a spent catalyst in-situ, a H₂ permeate gas stream, and a retentate gas stream. In some embodiments, the hydrogen-permeable membrane allows only H₂ to pass through in the formation of the H₂ permeate gas stream. In some embodiments, the S is present in the retentate gas stream in the form of a vapor. The method further includes collecting the H₂ permeate gas stream and separating the S from the retentate gas stream by introducing the retentate gas stream into a condenser and cooling the retentate gas steam to a temperature of about 110 to about 400° C., thereby generating the S in a liquid form and a H₂S-containing recycle gas stream leaving the condenser.

In some embodiments, the H₂S is present in the H₂S-containing feed gas stream at a concentration of about 20 to about 95 volume percentage (vol. %) based on a total volume of the H₂S-containing feed gas stream.

In some embodiments, the H₂S-containing feed gas stream further contains one or more gases selected from the group consisting of carbon dioxide (CO₂), water (H₂O), ammonia (NH₃), methane (CH₄), carbon disulfide (CS₂), carbonyl sulfide (COS), benzene, toluene, and xylene.

In some embodiments, the H₂S is present in the retentate gas stream at a concentration of less than about 10 vol. % based on a total volume of the retentate gas stream.

In some embodiments, the H₂S-containing feed gas stream is passed through the membrane reactor under pressure of about 5 to about 20 atmospheric pressure (atm).

In some embodiments, the H₂S-containing feed gas stream is passed through the membrane reactor at a temperature of about 450 to about 800° C.

In some embodiments, the H₂S-containing feed gas stream is introduced into two or more membrane reactors. In some embodiments, the two or more membrane reactors are arranged in parallel with each other.

In some embodiments, the H₂S-containing feed gas stream is introduced into two or more membrane reactors. In some embodiments, the two or more membrane reactors are arranged in series with each other.

In some embodiments, each of the one or more membrane reactors is in the form of a horizontal tubular reactor. The horizontal tubular reactor includes two gas inlets, two retentate gas outlets, one H₂ permeate gas outlet, two hydrogen-permeable membranes located within a body portion of the horizontal tubular reactor and separated by a H₂ permeate gas chamber, and two retentate gas chambers. In some embodiments, the H₂ permeate gas chamber is coaxially disposed within the horizontal tubular reactor, and is in in fluid communication with the H₂ permeate gas outlet. In some embodiments, each of the two retentate gas chambers contains a first end and a second end opposite to the first end. In some embodiments, one of the two gas inlets is disposed on the first end of the retentate gas chamber. In some embodiments, one of the two gas outlets is disposed on the second end of the same retentate gas chamber.

In some embodiments, the one or more catalyst layers of each of the two hydrogen-permeable membranes are in direct contact with each of the two corresponding retentate gas chambers.

In some embodiments, the metallic layer of each of the two hydrogen-permeable membranes is in direct contact with the H₂ permeate gas chamber.

In some embodiments, each of the one or more membrane reactors is in the form of a packed bed membrane reactor. In some embodiments, the packed bed membrane reactor includes one gas inlet, one retentate gas outlet, two H₂ permeate gas outlets, two hydrogen-permeable membranes located within a body portion of the packed bed membrane reactor and separated by a H₂S decomposition catalyst bed, and two H₂ permeate gas chambers. In some embodiments, the H₂S decomposition catalyst bed is coaxially located within the packed bed membrane reactor, a first end of the H₂S decomposition catalyst bed is in in fluid communication with the gas inlet, and a second end of the H₂S decomposition catalyst bed is in in fluid communication with the retentate gas outlet. In some embodiments, each of the two H₂ permeate gas chambers contains a first end and a second end opposite to the first end. In some embodiments, one of the two H₂ permeate gas outlets is disposed on the second end of the corresponding H₂ permeate gas chamber.

In some embodiments, the one or more catalyst layers of each of the two hydrogen-permeable membranes are in direct contact with the H₂S decomposition catalyst bed.

In some embodiments, the metallic layer of each of the two hydrogen-permeable membranes is in direct contact with each of the two corresponding H₂ permeate gas chambers. In some embodiments, the metallic layer of the hydrogen-permeable membrane contains palladium, vanadium, niobium, tantalum, or a mixture thereof in combination with one or more of copper, gold, platinum, indium, ruthenium as binary, ternary, or quaternary alloys.

In some embodiments, the protective layer of the hydrogen-permeable membrane contains a metal carbide or a metal sulfide.

In some embodiments, the protective layer contains a metal carbide selected from the group consisting of chromium carbide, molybdenum carbide, niobium carbide, tantalum carbide, titanium carbide, tungsten carbide, vanadium carbide, and combinations thereof.

In some embodiments, the H₂S decomposition catalyst of each of the one or more catalyst layers contains a metal sulfide or a bimetallic alloy.

In some embodiments, the H₂S decomposition catalyst contains a metal sulfide selected from the group consisting of molybdenum disulfide, iron sulfide, and combinations thereof.

In some embodiments, the H₂S decomposition catalyst is molybdenum disulfide in the form of a flower-like nanosheet microsphere having an average particle size of about 400 to about 1000 nanometers (nm).

In an exemplary embodiment, the method for converting H₂S to H₂ and S further includes preparing the hydrogen-permeable membrane by one or more techniques selected from the group consisting of electroplating, electroless plating, physical vapor deposition (PVD), chemical vapor deposition (CVD), atomic layer deposition (ALD), catalyst impregnation, modulated pulsed power magnetron sputtering (MPPMS), and high-power pulsed magnetron sputtering (HPPMS).

### BRIEF DESCRIPTION OF THE DRAWINGS

FIG. 1 shows a membrane reactor in the form of a horizontal tubular reactor, according to certain embodiments of the present disclosure.

FIG. 2 shows a membrane reactor in the form of a packed bed membrane reactor, according to certain embodiments of the present disclosure.

FIG. 3 is a flow diagram depicting an exemplary method for converting hydrogen sulfide (H₂S) to hydrogen (H₂) and sulfur (S), according to certain embodiments of the present disclosure.

FIG. 4 is a plotted graph illustrating hydrogen permeability results of different hydrogen-permeable membranes, according to certain embodiments of the present disclosure.

FIG. 5 is a plotted graph illustrating H₂S conversion results of a reactor containing a MoS₂ catalyst as compared to an empty reactor (in the absence of a MoS₂ catalyst) and the calculated thermodynamic equilibrium, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “room temperature” and “ambient temperature” refer to a temperature in a range of 25 degrees Celsius (° C.)±3° C. in the present disclosure.

As used herein, the terms “particle size” and “pore size” are thought of as the lengths or longest dimensions of a particle and of a pore opening, respectively.

As used herein, the term “de-ionized water” refers to the water that has (most of) the ions removed.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the terms “metal organic framework,” or “MOF,” refer to a coordination network with organic ligands containing potential voids. A coordination network is a coordination compound extending, through repeating coordination entities, in one dimension, but with cross-links between two or more individual chains, loops, or spiro-links, or a coordination compound extending through repeating coordination entities in two or three dimensions. A coordination entity is an ion or neutral molecule that is composed of a central atom, usually that of a metal, to which is attached a surrounding array of atoms or groups of atoms, each of which is called a ligand. More succinctly, a metal organic framework is characterized by metal ions or clusters coordinated to organic ligands to form one-, two-, or three-dimensional structures. A MOF exhibits a regular void or pore structure. The nature of the void or pore structure may be impacted by various properties or structural factors. These properties include the geometry of the metal ions or clusters, the arrangement of the linkages between metal ions or clusters, and the number, identity, and spatial arrangement of voids or pores. These properties may be described as the structure of the repeat units and the nature of the arrangement of the repeat units. The specific structure of the MOF, which may include the void or pore structure, is referred to as the MOF topology.

MOF-containing imidazole or benzimidazole ligands are referred to as zeolitic imidazolate frameworks (ZIFs). As used herein, the terms “zeolitic,” “zeolite,” or “zeolitic materials” refer to a material having the crystalline structure or three-dimensional framework of a zeolite. Zeolites are porous silicate or aluminosilicate minerals that occur in nature. Elementary building units of zeolites are SiO₄ (and if appropriate, AlO₄) tetrahedra. Adjacent tetrahedra are linked at their corners via a common oxygen atom, which results in an inorganic macromolecule with a three-dimensional framework (also referred to as the zeolite framework). The three-dimensional framework of a zeolite also comprises channels, channel intersections, and cages having dimensions in the range of about 0.1 to about 10 nm, such as about 0.2 to about 5 nm, or about 0.2 to about 2 nm. Water molecules may be present inside these channels, channel intersections, and/or cages. Zeolites which are devoid of aluminum may be referred to as “all-silica zeolites” or “aluminum-free zeolites”. Some zeolites which are substantially free of, but not devoid of, aluminum are referred to as “high-silica zeolites”.

As used herein, the term “uniform shape” refers to an average consistent shape, including but not limited to, a flower-like nanosheet microsphere or a nanosheet, that differs by no more than about 10%, such as by no more than about 5%, by no more than about 4%, by no more than about 3%, by no more than about 2%, or by no more than about 1% of the distribution of particles having a different shape.

As used herein, the term “non-uniform shape” refers to an average consistent shape that differs by more than about 10%, such as more than about 15%, more than about 20%, or more than about 30% of the distribution of particles having a different shape.

In the methods described in this disclosure, the acts can be carried out in any order, except when a temporal or operational sequence is explicitly recited. Furthermore, specified acts can be carried out concurrently unless explicit claim language recites that they be carried out separately.

For example, a claimed act of doing X and a claimed act of doing Y can be conducted simultaneously within a single operation, and the resulting process will fall within the literal scope of the claimed process.

In view of the foregoing, one objective of the present disclosure is to provide a method for converting hydrogen sulfide to hydrogen and sulfur using membrane reactors containing hydrogen-permeable membranes. A second objective of the present disclosure is to provide methods for making and using the membrane reactors. A third objective of the present disclosure is to provide methods for making and using the hydrogen-permeable membranes.

Provided in the present disclosure is a method for converting hydrogen sulfide (H₂S) to hydrogen (H₂) and sulfur (S), as illustrated in Scheme 1. The method of the present disclosure is effective in recovering the high-value product, H₂, from H₂S under mild conditions, achieving high yield and production rates using a hydrogen-permeable membrane-containing membrane reactor. Additionally, the present disclosure includes methods of making and using the membrane reactor and the hydrogen-permeable membrane. The hydrogen-permeable membrane, containing H₂S decomposition catalysts like metal sulfide catalysts, can be prepared through a simple process, resulting in enhanced surface areas and controlled morphologies, making it suitable for large-scale production and manufacturing application.

$${H}_{2} S ( g ) \to {H}_{2} ( g ) + \frac{1}{2} {S}_{2} ( g ) \qquad Scheme 1$$

According to an aspect of the present disclosure, a method for converting H₂S to H₂ and S includes introducing a H₂S-containing feed gas stream into one or more membrane reactors. In some embodiments, each of the one or more membrane reactors contains a hydrogen-permeable membrane in a multi-layered structure. In some embodiments, the hydrogen-permeable membrane includes a metallic layer, a protective layer disposed on the metallic layer, and one or more catalyst layers disposed on the protective layer. In some embodiments, each of the one or more catalyst layers contains a H₂S decomposition catalyst.

In some embodiments, the metallic layer of the hydrogen-permeable membrane contains palladium, vanadium, niobium, tantalum, or a mixture thereof in combination with one or more of copper, gold, platinum, indium, ruthenium as binary, ternary, or quaternary alloys. In some embodiments, the metallic layer of the hydrogen-permeable membrane contains palladium with one or more of copper, gold, platinum, indium, ruthenium as binary, ternary, or quaternary alloys.

In some embodiments, the metallic layer of the hydrogen-permeable membrane contains palladium with gold. In some embodiments, the metallic layer of the hydrogen-permeable membrane contains palladium with copper. In some embodiments, the metallic layer of the hydrogen-permeable membrane contains palladium with platinum. In some embodiments, the metallic layer of the hydrogen-permeable membrane contains palladium with indium. In some embodiments, the metallic layer of the hydrogen-permeable membrane contains palladium with ruthenium. Examples of suitable metallic layer of the hydrogen-permeable membrane includes, but are not limited to, palladium-copper alloys, palladium-gold alloys, palladium-platinum alloys, palladium-indium alloys, palladium-ruthenium alloys, palladium-gold-platinum alloys, palladium-ruthenium-indium alloys, vanadium-copper alloys, vanadium-gold alloys, vanadium-platinum alloys, vanadium-indium alloys, vanadium-ruthenium alloys, vanadium-gold-platinum alloys, vanadium-ruthenium-indium alloys, niobium-copper alloys, niobium-gold alloys, niobium-platinum alloys, niobium-indium alloys, niobium-ruthenium alloys, niobium-gold-platinum alloys, niobium-ruthenium-indium alloys, tantalum-copper alloys, tantalum-gold alloys, tantalum-platinum alloys, tantalum-indium alloys, tantalum-ruthenium alloys, tantalum-gold-platinum, and tantalum-ruthenium-indium alloys.

In some embodiments, the protective layer of the hydrogen-permeable membrane contains a metal carbide and a metal sulfide. In some embodiments, the metal carbide is selected from the group consisting of chromium carbide, molybdenum carbide, niobium carbide, tantalum carbide, titanium carbide, tungsten carbide, vanadium carbide, and combinations thereof. In some embodiments, the metal carbide is vanadium carbide. In some embodiments, the metal sulfide is selected from the group consisting of molybdenum disulfide (MoS₂), hafnium disulfide (HfS₂), platinum disulfide (PtS₂), tantalum disulfide (TaS₂), vanadium disulfide (VS₂), niobium disulfide (NbS₂), zirconium disulfide (ZrS₂), and titanium disulfide (TiS₂). In some embodiments, the metal sulfide includes MoS₂ and/or VS₂.

In some embodiments, the H₂S decomposition catalyst of each of the one or more catalyst layers contains a metal sulfide or a bimetallic alloy. In some embodiments, the H₂S decomposition catalyst contains a metal sulfide selected from the group consisting of molybdenum disulfide (MoS₂), iron sulfide, and combinations thereof. In some embodiments, the iron sulfide includes one or more of pyrite (FeS₂), marcasite (FeS₂), troilite (FeS), mackinawite (Fe₉S₈), greigite (Fe₃S₄), pyrrhotite (Fe₁₋ₓS), cubanite (CuFe₂S₃), and valleriite (Fe₂S₄Mg₄(OH)₆). In some embodiments, the metal sulfide used in the protective layer and the H₂S decomposition catalyst is the same, such as MoS₂. In further embodiments, the metal sulfide used in the protective layer differs from that used as the H₂S decomposition catalyst, allowing for tailored functionality between the protective layer and the H₂S decomposition catalyst.

In some embodiments, the H₂S decomposition catalyst is MoS₂ in the form of a flower-like nanosheet microsphere having an average particle size of about 400 to about 1000 nanometers (nm), such as about 450 to about 950 nm, about 500 to about 900 nm, about 550 to about 850 nm, about 600 to about 800 nm, about 650 to about 750 nm, or about 700 nm. In further embodiments, the flower-like nanosheet microsphere of the MoS₂ catalyst has an average particle size of about 400 to about 700 nm. In further embodiments, the flower-like nanosheet microsphere of the MoS₂ catalyst has an average particle size of about 500 to about 600 nm. In further embodiments, the flower-like nanosheet microsphere of the MoS₂ catalyst has an average particle size of about 550 nm. In some embodiments, the flower-like nanosheet microsphere of the MoS₂ catalyst has a uniform shape.

In some embodiments, each flower-like nanosheet microsphere contains a hollow spherical core and a plurality of interconnected nanosheets growing perpendicular to a surface of the hollow spherical core. In some embodiments, the hollow spherical core of the flower-like nanosheet microsphere has an average diameter of about 20 to about 800 nm, such as about 40 to about 700 nm, about 60 to about 600 nm, about 80 to about 500 nm, about 100 to about 400 nm, about 120 to about 300 nm, about 140 to about 200 nm, or about 160 nm. In further embodiments, the hollow spherical core of the flower-like nanosheet microsphere has an average diameter of about 120 to about 200 nm. In further embodiments, the hollow spherical core of the flower-like nanosheet microsphere has an average diameter of about 140 to about 180 nm. In further embodiments, the hollow spherical core of the flower-like nanosheet microsphere has an average diameter of about 160 nm.

In some preferred embodiments, the plurality of interconnected nanosheets have an average width of about 50 to about 800 nm, such as about 70 to about 700 nm, about 90 to about 600 nm, about 110 to about 500 nm, about 130 to about 400 nm, about 150 to about 300 nm, or about 200 nm. In further embodiments, the plurality of interconnected nanosheets have an average width of about 200 to about 500 nm. In further embodiments, the plurality of interconnected nanosheets have an average width of about 250 to about 450 nm. In further embodiments, the plurality of interconnected nanosheets have an average width of about 300 to about 400 nm. In further embodiments, the plurality of interconnected nanosheets have an average width of about 350 nm.

In some more preferred embodiments, the plurality of interconnected nanosheets has an average thickness of about 0.5 to about 100 nm, such as about 1 to about 80 nm, about 3 to about 60 nm, about 5 to about 40 nm, about 7 to about 20 nm, or about 5 nm, about 10 nm, about 15 nm, about 20 nm, about 25 nm, about 30 nm, about 35 nm, about 40 nm, about 40 nm, about 45 nm, about 50 nm, about 55 nm, about 60 nm, about 65 nm, about 70 nm, or about 75 nm. In further embodiments, the plurality of interconnected nanosheets has an average thickness of about 10 to about 80 nm. In further embodiments, the plurality of interconnected nanosheets has an average thickness of about 10 to about 70 nm. In further embodiments, the plurality of interconnected nanosheets has an average thickness of about 10 to about 60 nm. In further embodiments, the plurality of interconnected nanosheets has an average thickness of about 10 to about 50 nm. In further embodiments, the plurality of interconnected nanosheets has an average thickness of about 10 to about 40 nm. In further embodiments, the plurality of interconnected nanosheets has an average thickness of about 10 to about 30 nm. In further embodiments, the plurality of interconnected nanosheets has an average thickness of about 10 to about 20 nm.

In some embodiments, the flower-like nanosheet microsphere of the MoS₂ catalyst has a surface area in a range of about 5 to about 100 square meters per gram (m²/g), such as about 10 to about 80 m²/g, about 20 to about 60 m²/g, about 30 to about 40 m²/g, or about 10 m²/g, about 20 m²/g, about 30 m²/g, about 40 m²/g, about 50 m²/g, about 60 m²/g, about 70 m²/g, about 80 m²/g, or about 90 m²/g, as determined by a Brunauer-Emmett-Teller (BET) method. In some embodiments, the flower-like nanosheet microsphere of the MoS₂ catalyst has a surface area of about 22 m²/g, as determined by the Brunauer-Emmett-Teller (BET) method. In some embodiments, the flower-like nanosheet microsphere of the MoS₂ catalyst has a surface area of about 32 m²/g, as determined by the Brunauer-Emmett-Teller (BET) method. In some embodiments, the flower-like nanosheet microsphere of the MoS₂ catalyst has a surface area of about 42 m²/g, as determined by the Brunauer-Emmett-Teller (BET) method.

In some embodiments, the flower-like nanosheet microsphere of the MoS₂ catalyst has a pore volume in a range of about 20 to about 250 cubic centimeters per gram (cm³/g), such as about 50 to about 200 cm³/g, about 100 to about 150 cm³/g, or about 85 cm³/g, about 105 cm³/g, about 125 cm³/g, about 145 cm³/g, about 165 cm³/g, or about 185 cm³/g, at a relative pressure of about 1, as determined by N₂ adsorption/desorption isotherms. In further embodiments, the flower-like nanosheet microsphere of the MoS₂ catalyst has a pore of about 110 to about 140 cm³/g at a relative pressure of about 1, as determined by the N₂ adsorption/desorption isotherms. In further embodiments, the flower-like nanosheet microsphere of the MoS₂ catalyst has a pore of about 120 to about 130 cm³/g at a relative pressure of about 1, as determined by the N₂ adsorption/desorption isotherms. In further embodiments, the flower-like nanosheet microsphere of the MoS₂ catalyst has a pore of about 125 cm³/g at a relative pressure of about 1, as determined by the N₂ adsorption/desorption isotherms.

In some embodiments, the flower-like nanosheet microsphere of the MoS₂ catalyst has an average pore diameter of about 2 to about 90 nm, such as about 5 to about 70 nm, about 10 to about 50 nm, about 15 to about 30 nm, or about 10 nm, about 20 nm, about 30 nm, about 40 nm, about 50 nm, about 60 nm, about 70 nm, or about 80 nm. In further embodiments, the flower-like nanosheet microsphere of the MoS₂ catalyst has an average pore diameter of about 10 to about 50 nm. In further embodiments, the flower-like nanosheet microsphere of the MoS₂ catalyst has an average pore diameter of about 15 to about 25 nm. In further embodiments, the flower-like nanosheet microsphere of the MoS₂ catalyst has an average pore diameter of about 20 nm.

Optionally, the H₂S decomposition catalyst may be supported on a support material to form a catalyst composite. In some embodiments, the support material is selected from the group consisting of a metal oxide, a carbon material, a silica material, and combinations thereof.

In some embodiments, the carbon material includes, but is not limited to, carbon nanotubes, carbon nanobuds, carbon nanoscrolls, carbon dots, activated carbon, carbon black, graphene, graphene oxide, reduced graphene oxide, and nanodiamonds. In some embodiments, the carbon material is selected from the group consisting of graphene, graphene oxide, reduced graphene oxide, carbon nanotubes, carbon dots, activated carbon, and mixtures thereof. In some embodiments, the metal oxide includes, but is not limited to, a metal organic framework (MOF), a zeolitic imidazolate framework (ZIF), and an inorganic oxide. In some embodiments, the silica material includes, but is not limited to, a clay and a silica-containing covalent organic polymer (COP). Examples of the catalyst composite include, but are not limited to, a metal oxide-supported MoS₂ catalyst, a carbon nanotube-supported MoS₂ catalyst, an activated carbon-supported MoS₂ catalyst, a MOF-supported MoS₂ catalyst, a ZIF-supported MoS₂ catalyst, and a COP-supported MoS₂ catalyst.

In some embodiments, the carbon material is carbon nanotubes. The carbon nanotubes may be any suitable carbon nanotubes known to one of ordinary skill in the art. Carbon nanotubes may be classified by structural properties such as the number of walls or the geometric configuration of the atoms that make up the nanotube. Classified by their number of walls, the carbon nanotubes can be single-walled carbon nanotubes (SWCNT) which have only one layer of carbon atoms arranged into a tube, or multi-walled carbon nanotubes (MWCNT), which have more than one single-layer tube of carbon atoms arranged so as to be nested, one tube inside another, each tube sharing a common orientation. Closely related to MWNTs are carbon nanoscrolls.

Carbon nanoscrolls are structures similar in shape to a MWCNT, but made of a single layer of carbon atoms that has been rolled onto itself to form a multi-layered tube with a free outer edge on the exterior of the nanoscroll and a free inner edge on the interior of the scroll and open ends. The end-on view of a carbon nanoscroll has a spiral-like shape. For the purposes of this disclosure, carbon nanoscrolls are considered a type of MWCNT. Classified by the geometric configuration of the atoms that make up the nanotube, carbon nanotubes can be described by a pair of integer indices n and m. The indices n and m denote the number of unit vectors along two directions in the honeycomb crystal lattice of a single layer of carbon atoms. If m=0, the nanotubes are called zigzag type nanotubes. If n=m, the nanotubes are called armchair type nanotubes. Otherwise, they are called chiral type nanotubes. In some embodiments, the carbon nanotubes are metallic.

In some embodiments, the carbon nanotubes are semiconducting. In some embodiments, the carbon nanotubes are SWCNTs. In some embodiments, the carbon nanotubes are MWCNTs. In some embodiments, the carbon nanotubes are carbon nanoscrolls. In some embodiments, the carbon nanotubes are zigzag type nanotubes. In some embodiments, the carbon nanotubes are armchair type nanotubes. In some embodiments, the carbon nanotubes are chiral type nanotubes.

In some embodiments, the particles of a carbon nanomaterial are a single type of particle as described herein. In this context, “a single type of particle” refers to particles of a single carbon nanomaterial, particles which have substantially the same shape, particles which have substantially the same size, or any combination of these.

In some embodiments, the metal organic framework is a zeolitic imidazolate framework.

In some embodiments, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g., gonnardite, natrolite, mesolite, paranatrolite, scolecite, and tetranatrolite), edingtonite framework (e.g., edingtonite and kalborsite), thomsonite framework, analcime framework (e.g., analcime, leucite, pollucite, and wairakite), phillipsite framework (e.g., harmotome), gismondine framework (e.g., amicite, gismondine, garronite, and gobbinsite), chabazite framework (e.g., chabazite-series, herschelite, willhendersonite, and SSZ-13), faujasite framework (e.g., faujasite-series, Linde type X, and Linde type Y), mordenite framework (e.g., maricopaite and mordenite), heulandite framework (e.g., clinoptilolite and heulandite-series), stilbite framework (e.g., barrerite, stellerite, and stilbite-series), brewsterite framework, or cowlesite framework. Examples of suitable metal organic frameworks include, but are not limited to, isoreticular metal organic framework-3 (IRMOF-3), MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH2, UMCM-1-NH2, MOF-69-80, ZIF-1, ZIF-2, ZIF-3, ZIF-4, ZIF-5, ZIF-6, ZIF-7, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, and ZIF-725.

In some embodiments, the metal oxide is an inorganic metal oxide selected from the group consisting of aluminum oxide, zinc oxide, copper oxide, nickel oxide, cobalt oxide, manganese oxide, chromium oxide, cadmium oxide, magnesium oxide, zirconium oxide, and mixtures thereof.

In some embodiments, the support material is aluminum oxide. In some embodiments, the aluminum oxide is gamma (γ) aluminum oxide. Examples of aluminum oxide include, but are not limited to, alumina, silica-alumina, alumina-titania, alumina-zirconia, alumina-boria, phosphorus-alumina, silica alumina-boria, phosphorus-alumina-boria, phosphorus-alumina-silica, silica-alumina-titania, silica-alumina-zirconia, or mixtures thereof.

In some embodiments, the support material is present in the form of particles. The particles can be any shape known to one of ordinary skill in the art. Examples of suitable shapes the support material particles may take include spheres, spheroids, lentoids, ovoids, solid polyhedra such as tetrahedra, cubes, octahedra, icosahedra, dodecahedra, rectangular prisms, triangular prisms (also known as nanotriangles), nanoplatelets, nanodisks, nanotubes, blocks, flakes, discs, granules, angular chunks, or combinations thereof.

In some embodiments, the support material particles have uniform shape. In one embodiment, the shape is uniform and at least about 90% of the support material particles are spherical or substantially circular, and less than about 10% are polygonal. In further embodiments, the support material particles have non-uniform shape. In one embodiment, the shape is non-uniform and less than about 90% of the material particles are spherical or substantially circular, and greater than about 10% are polygonal.

In some embodiments, the H₂S is present in the H₂S-containing feed gas stream at a concentration of about 0.1 to about 99 volume percentage (vol. %), such as about 5 to about 95 vol. %, about 10 to about 90 vol. %, about 15 to about 85 vol. %, about 20 to about 80 vol. %, about 25 to about 75 vol. %, about 30 to about 70 vol. %, about 35 to about 65 vol. %, about 40 to 5 about 60 vol. %, about 45 to about 55 vol. %, or about 2 vol. %, about 4 vol. %, about 8 vol. %, about 16 vol. %, about 32 vol. %, about 64 vol. %, or about 95 vol. % based on a total volume of the H₂S-containing feed gas stream. In further embodiments, the H₂S-containing feed gas stream includes H₂S at a concentration of about 20 vol. %, based on the total volume of the H₂S-containing feed gas stream. In further embodiments, the H₂S-containing feed gas stream includes H₂S at a concentration of about 40 vol. %, based on the total volume of the H₂S-containing feed gas stream. In further embodiments, the H₂S-containing feed gas stream includes H₂S at a concentration of about 60 vol. %, based on the total volume of the H₂S-containing feed gas stream. In further embodiments, the H₂S-containing feed gas stream includes H₂S at a concentration of about 80 vol. %, based on the total volume of the H₂S-containing feed gas stream.

In some embodiments, the H₂S-containing feed gas stream further includes one or more gases selected from the group consisting of carbon dioxide (CO₂), water (H₂O) vapor, ammonia (NH₃), methane (CH₄), carbon disulfide (CS₂), carbonyl sulfide (COS), benzene, toluene, and xylene. In some embodiments, the H₂S-containing feed gas stream further includes an inert gas selected from the group consisting of nitrogen, argon, and helium. In some embodiments, the H₂S-containing feed gas stream includes H₂S, CO₂, water vapor, NH₃, CH₄, CS₂, COS, benzene, toluene, and xylene. In some embodiments, the H₂S is present in the H₂S-containing feed gas stream in a range of about 20 to about 95 vol. %, such as about 30 to about 85 vol. %, about 40 to about 75 vol. %, about 50 to about 65 vol. %, or about 55 vol. % based on the total volume of the H₂S-containing feed gas stream. In some embodiments, the CO₂ is present in the H₂S-containing feed gas stream in a range of about 5 to about 75 vol. %, such as about 15 to about 65 vol. %, about 25 to about 55 vol. %, about 35 to about 45 vol. %, or about 40 vol. % based on the total volume of the H₂S-containing feed gas stream. In some embodiments, the water vapor is present in the H₂S-containing feed gas stream in a range of about 1 to about 10 vol. %, such as about 2 to about 9 vol. %, about 3 to about 8 vol. %, about 4 to about 7 vol. %, or about 5 to about 6 vol. % based on the total volume of the H₂S-containing feed gas stream. In some embodiments, the NH₃ is present in the H₂S-containing feed gas stream in a range of about 0.01 to about 10 vol. %, such as about 1 to about 9 vol. %, about 2 to about 8 vol. %, about 3 to about 7 vol. %, about 4 to about 6 vol. %, or about 5 vol. % based on the total volume of the H₂S-containing feed gas stream. In some embodiments, the CH₄ is present in the H₂S-containing feed gas stream in a range of about 0.01 to about 5 vol. %, such as about 0.5 to about 4.5 vol. %, about 1 to about 4 vol. %, about 1.5 to about 3.5 vol. %, about 2 to about 3 vol. %, or about 3.5 vol. % based on the total volume of the H₂S-containing feed gas stream. In some embodiments, the CS₂ is present in the H₂S-containing feed gas stream in a range of about 0.01 to about 5 vol. %, such as about 0.5 to about 4.5 vol. %, about 1 to about 4 vol. %, about 1.5 to about 3.5 vol. %, about 2 to about 3 vol. %, or about 3.5 vol. % based on the total volume of the H₂S-containing feed gas stream. In some embodiments, the COS is present in the H₂S-containing feed gas stream in a range of about 0.01 to about 5 vol. %, such as about 0.5 to about 4.5 vol. %, about 1 to about 4 vol. %, about 1.5 to about 3.5 vol. %, about 2 to about 3 vol. %, or about 3.5 vol. % based on the total volume of the H₂S-containing feed gas stream. In some embodiments, the benzene is present in the H₂S-containing feed gas stream in a range of about 0.01 to about 5 vol. %, such as about 0.5 to about 4.5 vol. %, about 1 to about 4 vol. %, about 1.5 to about 3.5 vol. %, about 2 to about 3 vol. %, or about 3.5 vol. % based on the total volume of the H₂S-containing feed gas stream. In some embodiments, the toluene is present in the H₂S-containing feed gas stream in a range of about 0.01 to about 5 vol. %, such as about 0.5 to about 4.5 vol. %, about 1 to about 4 vol. %, about 1.5 to about 3.5 vol. %, about 2 to about 3 vol. %, or about 3.5 vol. % based on the total volume of the H₂S-containing feed gas stream. In some embodiments, the xylene is present in the H₂S-containing feed gas stream in a range of about 0.01 to about 5 vol. %, such as about 0.5 to about 4.5 vol. %, about 1 to about 4 vol. %, about 1.5 to about 3.5 vol. %, about 2 to about 3 vol. %, or about 3.5 vol. % based on the total volume of the H₂S-containing feed gas stream.

In some embodiments, the method for converting H₂S to H₂ and S includes passing the H₂S-containing feed gas stream through the one or more membrane reactors to contact the H₂S-containing feed gas stream with the H₂S decomposition catalyst of the hydrogen-permeable membrane, thereby converting at least a portion of the H₂S to H₂ and S and producing a spent catalyst in-situ, a H₂ permeate gas stream, and a retentate gas stream. In some embodiments, the hydrogen-permeable membrane allows only H₂ to pass through in the formation of the H₂ permeate gas stream. In some embodiments, the S is present in the retentate gas stream in the form of a vapor.

In some embodiments, the H₂S-containing feed gas stream is passed through the membrane reactor under pressure of about 1 to about 30 atmospheric pressure (atm), such as about 3 to about 27 atm, about 6 to about 24 atm, about 9 to about 21 atm, about 12 to about 18 atm, or about 15 atm.

In some embodiments, the H₂S-containing feed gas stream is passed through the membrane reactor at a temperature of about 400 to about 900° C., such as about 450 to about 850° C., about 500 to about 800° C., about 550 to about 750° C., about 600 to about 700° C., or about 450° C., about 500° C., about 550° C., about 600° C., about 650° C., about 700° C., about 750° C., about 800° C., or about 850° C. In further embodiments, the passing the H₂S-containing feed gas stream through the reactor is performed at a temperature of about 400° C. In further embodiments, the passing the H₂S-containing feed gas stream through the reactor is performed at a temperature of about 500° C. In further embodiments, the passing the H₂S-containing feed gas stream through the membrane reactor is performed at a temperature of about 600° C. In further embodiments, the passing the H₂S-containing feed gas stream through the membrane reactor is performed at a temperature of about 700° C. In further embodiments, the passing the H₂S-containing feed gas stream through the membrane reactor is performed at a temperature of about 800° C. In further embodiments, the passing the H₂S-containing feed gas stream through the membrane reactor is performed at a temperature of about 900° C.

In some embodiments, the passing the H₂S-containing feed gas stream through the membrane reactor is carried out at a spacetime of about 0.001 to about 10 grams seconds per milliliter (g s mL⁻¹), such as about 0.001 to about 8 g s mL⁻¹, about 0.01 to about 5 g s mL⁻¹, about 0.02 to about 1 g s mL⁻¹, about 0.03 to about 0.1 g s mL⁻¹, or about 0.03 g s mL⁻¹, at a temperature of about 700° C. In further embodiments, the passing the H₂S-containing feed gas stream through the membrane reactor is carried out at a spacetime of about 0.03 g s mL⁻¹.

In some embodiments, the H₂S is present in the retentate gas stream at a concentration of less than about 10 vol. % based on a total volume of the retentate gas stream. In further embodiments, the H₂S is present in the retentate gas stream at a concentration of less than about 9 vol. %, such as less than about 8 vol. %, less than about 7 vol. %, less than about 6 vol. %, less than about 5 vol. %, less than about 4 vol. %, less than about 3 vol. %, less than about 2 vol. %, less than about 1 vol. %, or less than about 0.1 vol. % based on the total volume of the retentate gas stream. In some embodiments, the retentate gas stream includes one or more of H₂S, H₂, CO₂, water vapor, NH₃, CH₄, CS₂, COS, benzene, toluene, and xylene. In some embodiments, the retentate gas stream includes H₂S, H₂, CO₂, water vapor, NH₃, CH₄, CS₂, COS, benzene, toluene, and xylene. In some embodiments, the H₂S is present in the retentate gas stream at a concentration of less than about 9 vol. %, such as less than about 8 vol. %, less than about 7 vol. %, less than about 6 vol. %, less than about 5 vol. %, less than about 4 vol. %, less than about 3 vol. %, less than about 2 vol. %, less than about 1 vol. %, or less than about 0.1 vol. % based on the total volume of the retentate gas stream. In some embodiments, the H₂ is present in the retentate gas stream at a concentration of less than about 1 to about 27 vol. %, such as about 2 to about 26 vol. %, about 3 to about 23 vol. %, about 4 to about 20 vol. %, about 5 to about 17 vol. %, about 6 to about 14 vol. %, about 7 to about 11 vol. %, or about 9 to about 10 vol. % based on the total volume of the retentate gas stream. In some embodiments, the CO₂ is present in the retentate gas stream at a concentration of less than about 5 to about 75 vol. %, such as about 10 to about 70 vol. %, about 15 to about 65 vol. %, about 20 to about 60 vol. %, about 25 to about 55 vol. %, about 30 to about 50 vol. %, about 35 to about 45 vol. %, or about 40 vol. % based on the total volume of the retentate gas stream. In some embodiments, the water vapor is present in the retentate gas stream at a concentration of less than about 10 vol. %, such as less than about 9 vol. %, less than about 8 vol. %, less than about 7 vol. %, less than about 6 vol. %, less than about 5 vol. %, less than about 4 vol. %, less than about 3 vol. %, less than about 2 vol. %, less than about 1 vol. %, or less than about 0.1 vol. % based on the total volume of the retentate gas stream. In some embodiments, the NH₃ is present in the retentate gas stream at a concentration of less than about 10 vol. %, such as less than about 9 vol. %, less than about 8 vol. %, less than about 7 vol. %, less than about 6 vol. %, less than about 5 vol. %, less than about 4 vol. %, less than about 3 vol. %, less than about 2 vol. %, less than about 1 vol. %, or less than about 0.1 vol. % based on the total volume of the retentate gas stream. In some embodiments, the CH₄ is present in the retentate gas stream at a concentration of less than about 5 vol. %, such as less than about 4 vol. %, less than about 3 vol. %, less than about 2 vol. %, less than about 1 vol. %, or less than about 0.1 vol. % based on the total volume of the retentate gas stream. In some embodiments, the CS₂ is present in the retentate gas stream at a concentration of less than about 5 vol. %, such as less than about 4 vol. %, less than about 3 vol. %, less than about 2 vol. %, less than about 1 vol. %, or less than about 0.1 vol. % based on the total volume of the retentate gas stream. In some embodiments, the COS is present in the retentate gas stream at a concentration of less than about 5 vol. %, such as less than about 4 vol. %, less than about 3 vol. %, less than about 2 vol. %, less than about 1 vol. %, or less than about 0.1 vol. % based on the total volume of the retentate gas stream. In some embodiments, the benzene is present in the retentate gas stream at a concentration of less than about 5 vol. %, such as less than about 4 vol. %, less than about 3 vol. %, less than about 2 vol. %, less than about 1 vol. %, or less than about 0.1 vol. % based on the total volume of the retentate gas stream. In some embodiments, the toluene is present in the retentate gas stream at a concentration of less than about 5 vol. %, such as less than about 4 vol. %, less than about 3 vol. %, less than about 2 vol. %, less than about 1 vol. %, or less than about 0.1 vol. % based on the total volume of the retentate gas stream. In some embodiments, the xylene is present in the retentate gas stream at a concentration of less than about 5 vol. %, such as less than about 4 vol. %, less than about 3 vol. %, less than about 2 vol. %, less than about 1 vol. %, or less than about 0.1 vol. % based on the total volume of the retentate gas stream.

In some embodiments, the H₂S-containing feed gas stream is introduced into two or more membrane reactors. In some embodiments, the two or more membrane reactors are arranged in parallel with each other. In some further embodiments, the two or more membrane reactors are arranged in series with each other.

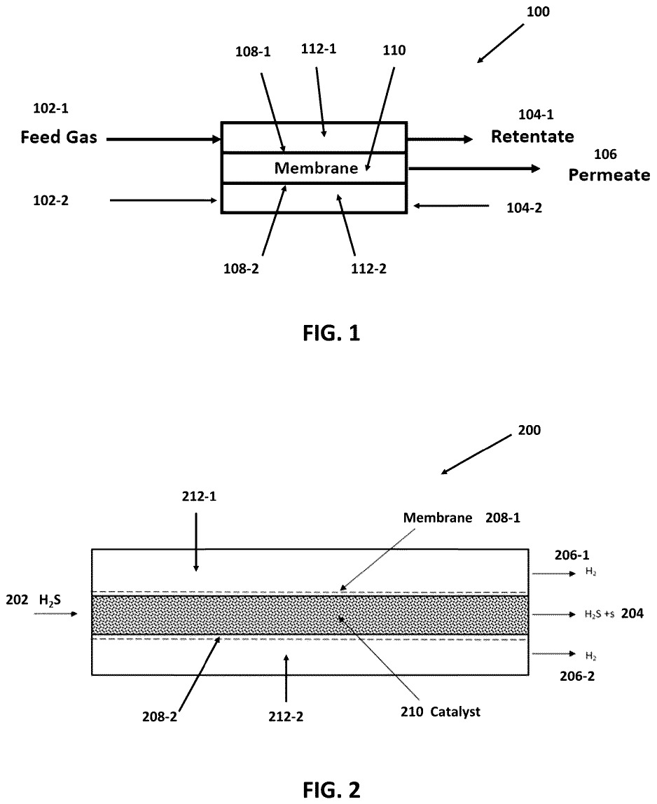

In an exemplary embodiment, each of the one or more membrane reactors is in the form of a horizontal tubular reactor, as depicted in FIG. 1. In some embodiments, each membrane reactor in the form of a horizontal tubular reactor (100) contains two gas inlets (102-1 and 102-2), two retentate gas outlets (104-1 and 104-2), one H₂ permeate gas outlet (106), two hydrogen-permeable membranes (108-1 and 108-2) located within a body portion of the horizontal tubular reactor (100) and separated by a H₂ permeate gas chamber (110), and two retentate gas chambers (112-1 and 112-2). In some embodiments, the two hydrogen-permeable membranes (108-1 and 108-2) are of the same size in a symmetric manner. In some embodiments, the two hydrogen-permeable membranes (108-1 and 108-2) are of different sizes. In some embodiments, the two retentate gas chambers (112-1 and 112-2) are of the same size in a symmetric manner. In some embodiments, the two retentate gas chambers (112-1 and 112-2) are of different sizes. In some embodiments, the H₂ permeate gas chamber (110) is coaxially disposed within the horizontal tubular reactor (100), and is in in fluid communication with the H₂ permeate gas outlet (106). In some embodiments, each of the two retentate gas chambers (112-1 and 112-2) includes a first end and a second end opposite to the first end. In some embodiments, one of the two gas inlets (102-1 and 102-2) is correspondingly disposed on the first end of the retentate gas chamber (112-1 and 112-2). In some embodiments, one of the two gas outlets (104-1 and 1041-2) is correspondingly disposed on the second end of the same retentate gas chamber (112-1 and 112-2). In some embodiments, the one or more catalyst layers of each of the two hydrogen-permeable membranes (108-1 and 108-2) are in direct contact with each of the two corresponding retentate gas chambers (112-1 and 112-2), respectively. In some embodiments, the metallic layer of each of the two hydrogen-permeable membranes (108-1 and 108-2) is in direct contact with the H₂ permeate gas chamber (110), respectively.

In an exemplary embodiment, each of the one or more membrane reactors is in the form of a packed bed membrane reactor (200), as depicted in FIG. 2. In some embodiments, the packed bed membrane reactor (200) includes one gas inlet (202), one retentate gas outlet (204), two H₂ permeate gas outlets (206-1 and 206-2), two hydrogen-permeable membranes (208-1 and 208-2) located within a body portion of the packed bed membrane reactor (200) and separated by a H₂S decomposition catalyst bed (210), and two H₂ permeate gas chambers (212-1 and 212-2). In some embodiments, the H₂S decomposition catalyst bed (210) is coaxially located within the packed bed membrane reactor (200). In some embodiments, a first end of the H₂S decomposition catalyst bed (210) is in fluid communication with the gas inlet (202), and a second end of the H₂S decomposition catalyst bed (210) is in fluid communication with the retentate gas outlet (204). In some embodiments, each of the two H₂ permeate gas chambers (212-1 and 212-2) includes a first end and a second end opposite to the first end. In some embodiments, one of the two H₂ permeate gas outlets (206-1 and 206-2) is correspondingly disposed on the second end of the corresponding H₂ permeate gas chamber (212-1 and 212-2). In some embodiments, the two H₂ permeate gas chambers (212-1 and 212-2) are of the same size in a symmetric manner. In some embodiments, the two H₂ permeate gas chambers (212-1 and 212-2) are of different sizes. In some embodiments, the one or more catalyst layers of each of the two hydrogen-permeable membranes (208-1 and 208-2) are in direct contact with the H₂S decomposition catalyst bed (210), respectively. In some embodiments, the metallic layer of each of the two hydrogen-permeable membranes (208-1 and 208-2) is in direct contact with each of the two corresponding H₂ permeate gas chambers (206-1 and 206-2), respectively.

In some embodiments, the conversion of H₂S to H₂ and S is about 4 to about 20% based on an initial concentration of the H₂S in the H₂S-containing feed gas stream at a temperature of about 700° C. In further embodiments, the conversion of H₂S to H₂ and S is about 6 to about 18%, such as about 7 to about 16%, about 8 to about 14%, or about 9 to about 12%, based on the initial concentration of the H₂S in the H₂S-containing feed gas stream at a temperature of about 700° C. In some embodiments, the conversion of H₂S to H₂ and S is about 8% based on an initial concentration of the H₂S in the H₂S-containing feed gas stream at a temperature of about 700° C. In some embodiments, the conversion of H₂S to H₂ and S is about 9% based on an initial concentration of the H₂S in the H₂S-containing feed gas stream at a temperature of about 700° C. In some embodiments, the conversion of H₂S to H₂ and S is about 10% based on an initial concentration of the H₂S in the H₂S-containing feed gas stream at a temperature of about 700° C. In some embodiments, the conversion of H₂S to H₂ and S is about 11% based on an initial concentration of the H₂S in the H₂S-containing feed gas stream at a temperature of about 700° C. In some embodiments, the conversion of H₂S to H₂ and S is about 12% based on an initial concentration of the H₂S in the H₂S-containing feed gas stream at a temperature of about 700° C. In some embodiments, the conversion of H₂S to H₂ and S is about 13% based on an initial concentration of the H₂S in the H₂S-containing feed gas stream at a temperature of about 700° C. In some embodiments, the conversion of H₂S to H₂ and S is about 14% based on an initial concentration of the H₂S in the H₂S-containing feed gas stream at a temperature of about 700° C. In some embodiments, the conversion of H₂S to H₂ and S is about 15% based on an initial concentration of the H₂S in the H₂S-containing feed gas stream at a temperature of about 700° C.

In some embodiments, the method for converting H₂S further includes regenerating the hydrogen-permeable membrane by washing the hydrogen-permeable membrane with two or more solvents and drying. In some embodiments, the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof. In some embodiments, the two or more solvents are polar protic solvents, including but not limited to, water, acetone, N-methyl 2-pyrrolidone (NMP), acetonitrile, dimethylformamide (DMF), dimethyl sulfoxide (DMSO), isopropanol, methanol, and mixtures thereof. In some embodiments, the two or more solvents are water and NMP. In some embodiments, the drying the hydrogen-permeable membrane is carried out at a temperature of about 50 to about 100° C., such as about 55 to about 95° C., about 60 to about 90° C., about 65 to about 85° C., about 70 to about 80° C., or about 75° C. In further embodiments, the hydrogen-permeable membrane is dried at a temperature of about 75° C.

Also provided in the present disclosure is a method for preparing the hydrogen-permeable membrane by one or more techniques selected from the group consisting of electroplating, electroless plating, physical vapor deposition (PVD), chemical vapor deposition (CVD), atomic layer deposition (ALD), catalyst impregnation, modulated pulsed power magnetron sputtering (MPPMS), and high-power pulsed magnetron sputtering (HPPMS). The hydrogen-permeable membrane includes a metallic layer, a protective layer disposed on the metallic layer, and one or more catalyst layers disposed on the protective layer. In some embodiments, each of the one or more catalyst layers contains a H₂S decomposition catalyst.

In some embodiments, the hydrogen-permeable membrane is prepared by applying a coating composition on the metallic layer of the hydrogen-permeable membrane. The coating composition can be applied onto a surface of the metallic layer via known methods such as brushing, spraying, dipping, and flow coating. For a uniform distribution of coating, an appropriate speed of air can be applied on the whole area of the hydrogen-permeable membrane.

In some embodiments, a second layer of coating composition can be applied to a surface of coated metallic layer of the hydrogen-permeable membrane to achieve a desired thickness.

In some embodiments, the one or more catalyst layers can be applied to the metallic layer of the hydrogen-permeable membrane by first depositing a thin layer of metal (e.g., Mo) onto a surface of the metallic layer (or the protective layer) to form a sample and then converting the deposited metal into metal sulfide (e.g., MoS₂) by exposing the sample to a sulfur-containing gas stream (e.g., a H₂S gas stream) at a temperature of about 200 to about 600° C., such as about 250 to about 550° C., about 300 to about 500° C., about 350 to about 450° C., or about 400° C.

The metallic layer of the hydrogen-permeable membrane in the membrane reactor of the present disclosure has a high H₂ permeability and an appropriate tolerance to sulfur. Examples of metallic layers of the hydrogen-permeable membrane include palladium-copper alloys, palladium-gold alloys, palladium-platinum alloys, palladium-indium alloys, palladium-ruthenium alloys, and combinations of these binary alloys (e.g., palladium-gold-platinum alloys and palladium-ruthenium-indium alloys). Other suitable metallic layers of the hydrogen-permeable membrane include vanadium layer, niobium layer, and tantalum layer.

Samples containing a thin layer (protective layer) of sulfur-tolerant palladium alloys and/or hydrogen permeable coatings (e.g., metal carbides, metal sulfides, and/or bimetallic alloys) can be prepared by coating the thin layer onto one side of the metallic layer in the formation of the hydrogen-permeable membrane. The metal carbides and metal sulfides of the thin layer include vanadium carbide and iron sulfide. In some embodiments, the prepared hydrogen-permeable membrane doesn't have sufficient sulfur tolerance for long-term stable operation when contacting with high sulfur concentration streams. In some embodiments, the prepared hydrogen-permeable membrane has sufficient sulfur tolerance for long-term stable operation when contacting with high sulfur concentration streams.

Samples containing one or more catalyst layers can be prepared by disposing a H₂S decomposition catalyst or a H₂S decomposition catalyst precursor onto a surface of the thin layer (protective layer) of the membrane. The H₂S decomposition catalyst serves to split the hydrogen sulfide into hydrogen and sulfur. Hydrogen can then permeate through the metallic layer of the membrane (exits at the permeate side) while the sulfur and unconverted hydrogen sulfide remain in the retentate side of the membrane.

When a H₂S decomposition catalyst precursor is applied to the surface of the protective layer of the membrane, the resulting sample is treated under heat to convert the H₂S decomposition catalyst precursor to the corresponding H₂S decomposition catalyst which was then uniformly disposed on the surface of the protective layer. The H₂S decomposition catalyst includes metal sulfides and/or bimetallic alloys, such as molybdenum disulfide, iron sulfide, and/or silver-bismuth. In some embodiments, a second catalyst layer is coated on a hydrogen-permeable membrane that already contains a layer of H₂S decomposition catalyst. In some embodiments, more than two catalyst layers are applied onto a hydrogen-permeable membrane that contains a layer of H₂S decomposition catalyst.

In some embodiments, the one or more catalyst layers are coated onto the membrane using a post-synthesis approach. Examples include, but not limited to, atomic layer deposition (ALD) and catalyst impregnation on the metallic layer. The catalyst coating can also be applied on a surface of a membrane reactor directly using a rolling approach on a tray or a painting brush for effective and balanced coverage with at least two layers to insure complete coverage to the total surface area of the metallic layer of the membrane reactor. For a uniform distribution of coating, gentle speed of air can be applied on the whole area of the metallic layer of the membrane reactor. After applying one layer of coating, it is heated and dried before the application of a second layer and catalyst and so on based on the desired thickness. In some embodiments, the one or more catalyst layers are applied onto the surface of the membrane using an air brush. In some embodiments, the one or more catalyst layers were applied onto the surface of the membrane by modulated pulsed power magnetron sputtering (MPPMS) or high-power pulsed magnetron sputtering (HPPMS) techniques. In such cases, the thickness, density, microstructure, porosity, adhesion, and catalytic properties of the one or more catalyst layers can also be controlled.

In some embodiments, the one or more catalyst layers are applied onto the surface of the membrane by depositing a thin layer of metal (e.g., molybdenum) onto the surface of the metallic membrane and then converting the deposited metal into metal sulfide (e.g., MoS₂) by exposing the metal (e.g., molybdenum) to a sulfur-containing gas stream (e.g., such as a H₂S gas stream) at high temperatures (e.g., >400° C.). Other methods that can be used to deposit the metal onto the surface of the membrane include, but are not limited to, electroplating, electroless plating, ALD, physical vapor deposition (PVD), and chemical vapor deposition (CVD).

### EXAMPLES

The following examples demonstrate methods for converting hydrogen sulfide to hydrogen and sulfur as described herein. The examples are provided solely for illustration and are not to be construed as limitations of the present disclosure, as many variations thereof are possible without departing from the spirit and scope of the present disclosure.

### Example 1: Membrane Reactors

FIG. 1 illustrated a H₂S decomposition catalyst that was introduced into the annular space surrounding the hydrogen-permeable membrane within membrane reactor.

FIG. 2 illustrated a H₂S decomposition catalyst that was introduced into a H₂S decomposition catalyst bed (tube) formed by the inner wall of the membrane reactor.

### Example 2: Hydrogen Sulfide (H₂S) Conversion Process

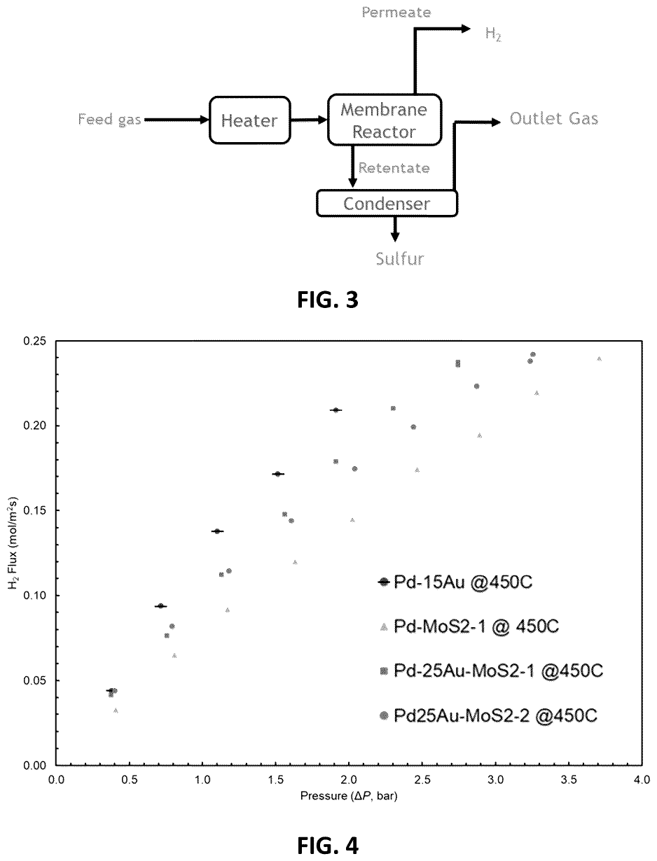

The membrane reactor was integrated into a chemical process. The chemical process of the present disclosure included a H₂S-containing feed gas stream, a heater, a membrane reactor, a condenser, a permeate stream, a retentate stream, a sulfur stream, and an outlet gas stream. An exemplary configuration of this process was illustrated in FIG. 3. The retentate stream, containing unconverted H₂S (as shown in the outlet gas of FIG. 3), was sent to an absorption-based treatment unit as a tail gas treatment unit (TGT), to ensure >99% of the sulfur was recovered. The TGT unit downstream of the process separated unconverted H₂S from CO₂, resulting in a high-purity CO₂ stream suitable for carbon capture and sequestration. Pre-treatment of the H₂S-containing feed gas might be necessary, depending on its composition. Impurities such as benzene, toluene, xylene, and ammonia were removed using conventional pre-treatment methods (e.g., adsorption, absorption, and/or membrane filtration) to protect the catalyst surface and the hydrogen-permeable membrane from poisoning.

An acid gas stream (also referred to herein as “a H₂S-containing feed gas stream”) at near atmospheric pressure was first compressed and heated to a temperature of about 600° C., and then the acid gas stream was introduced into a membrane reactor of FIG. 1. The membrane reactor of FIG. 1 had two types of outlets: a retentate outlet and a permeate outlet. Catalyst on the feed side of the hydrogen-permeable membrane was used to decompose (or “crack”) H₂S into hydrogen and sulfur while the catalyst layer on the hydrogen-permeable membrane served the same purpose and protected the hydrogen-permeable membrane from exposure to H₂S. Hydrogen subsequently diffused through the hydrogen-permeable membrane to the permeate side of the membrane. The retentate was then cooled into a condenser to separate molten S₂ from unconverted H₂S and H₂ (outlet gas). Condensers were capable of separating approximately 100% of gaseous sulfur by controlling (e.g., lowering) the stream temperature. In a first process configuration, unconverted H₂S present in the retentate gas stream at the outlet of the condenser (outlet gas) was recycled to the inlet of the membrane reactor via the H₂S-containing feed gas stream to increase the overall H₂S conversion. In a second process configuration, unconverted H₂S present in the retentate gas stream at the outlet of the condenser was fed into another membrane reactor in series, where steps depicted in the first process configuration took place. In such cases, the sizes of the membrane reactors were different depending on the flow rate and the H₂S concentration of the H₂S-containing feed gas stream. Four membrane reactors of FIG. 1 in the present disclosure were employed in series as depicted by the first process configuration. In a third process configuration, the H₂S-containing feed gas stream was compressed to about 20 atm. The increase of pressure could enhance the permeance of H₂ in the membrane reactor, thus reducing the size of the membrane reactor. In a fourth process configuration, the H₂S-containing feed gas stream was split before introducing into the one or more membrane reactors of FIG. 1 arranged in parallel. The number of membrane reactors of FIG. 1 that were arranged in parallel with each other was 2. The number of membrane reactors of FIG. 1 that were arranged in parallel with each other was 4. The number of membrane reactors of FIG. 1 that were arranged in parallel with each other was 6. This configuration could reduce the H₂S load on each membrane reactor. In a fifth process configuration, a H₂ permeate gas stream was fed into a gas separation process to remove contaminants from H₂, thereby producing a high purity H₂ stream. The gas separation processes used in the present chemical process included a pressure swing adsorption (PSA) process, an absorption separation process, and a cryogenic separation process.

An acid gas stream (also referred to herein as “a H₂S-containing feed gas stream”) at near atmospheric pressure was first compressed and heated to a temperature of about 600° C., and then the acid gas stream was introduced into a membrane reactor of FIG. 2. The H₂S-decomposition catalyst was packed in a tube featuring walls composed of membrane composite allowing only H₂ to pass through, as depicted in FIG. 2. The membrane composite contained thin metallic membrane deposited on an outer side of a protective material to prevent sulfur poisoning. In a first configuration, the H₂S-containing feed gas stream was compressed to an elevated pressure about 20 atm. The increase of pressure could enhance the permeance of H₂ in the membrane reactor, thus reducing the size of the membrane reactor. In a second configuration, four hydrogen-permeable membranes containing the H₂S decomposition catalyst were present in the form of a cylindrical tube within the shell of the membrane reactor, as depicted in FIG. 2. Additionally, a H₂S decomposition catalyst was coated onto an inner surface of the cylindrical tube to enhance the H₂S splitting. On one hand, a H₂S decomposition catalyst bed containing the H₂S-decomposition catalyst was coaxially located within the inner cavity of the cylindrical tube. The H₂S decomposition catalyst bed containing the H₂S-decomposition catalyst the same as the H₂S decomposition catalyst coated on the inner surface of the cylindrical tube was tested. On the other hand, the H₂S decomposition catalyst bed containing the H₂S-decomposition catalyst different from the H₂S decomposition catalyst coated on the inner surface of the cylindrical tube was also tested. The H₂S decomposition catalyst coated onto the inner surface of the cylindrical tube was capable of increasing the overall turnover frequency (TOF) of the H₂S splitting reaction as shown in Scheme 1. catalyst should also have a high porosity to avoid mass transfer limitations. This H₂S decomposition

### Example 3: Chemical Composition of Membrane Reactor Feed and Outlet Streams

The feed stream in the process disclosed by the present disclosure had H₂S, in the form of an acid gas produced by separating H₂S and CO₂ from natural gas (e.g., via an amine-based absorption process). This stream contained the following species and their concentrations were listed in Table 1.

TABLE 1
Chemical composition of the feed stream (also referred
herein as H₂S-containing feed gas stream)

| Chemical species | Concentration (vol. %) |
|---|---|
| Hydrogen sulfide (H₂S) | 20-95 |
| Carbon dioxide (CO₂) | 5-75 |
| Water (H₂O) | 1-10 |
| Ammonia (NH₃) | 0-10 |
| Methane (CH₄) | 0-5 |
| Carbon disulfide (CS₂) | 0-5 |
| Carbonyl sulfide (COS) | 0-5 |
| Benzene, toluene, and xylene (BTX) | 0-5 |

The outlet stream in the process disclosed by the present disclosure had the following species and their concentrations were listed in Table 2 below.

TABLE 2
Chemical composition of the outlet stream (also
referred herein as retentate gas stream)

| Chemical species | Concentration (vol. %) |
|---|---|
| Hydrogen sulfide (H₂S) | 0-10 |
| Hydrogen (H₂) | 0-15 |
| Carbon dioxide (CO₂) | 5-75 |
| Water (H₂O) | 0-10 |
| Ammonia (NH₃) | 0-10 |
| Methane (CH₄) | 0-5 |
| Carbon disulfide (CS₂) | 0-5 |
| Carbonyl sulfide (COS) | 0-5 |
| Benzene, toluene, and xylene (BTX) | 0-5 |

### Example 4: H₂S Splitting

Four different palladium (Pd)-based hydrogen-permeable membranes were prepared according to Table 3 below. Each % as shown in Table 3 is based on a total weight of the corresponding Pd-based hydrogen-permeable membrane. These membranes were then tested for hydrogen permeability and H₂S splitting performance in accordance with the present disclosure.

TABLE 3
Palladium (Pd)-based hydrogen-permeable membranes

| Sample ID | Sample description |
|---|---|
| Pd-15Au | 15% elemental gold (Au) coated on a surface of a Pd |
| | substrate layer |
| Pd-MoS₂-1 | A molybdenum disulfide (MoS₂) catalyst coated on a |
| | surface of a Pd substrate layer |
| Pd-25Au-MoS₂-1 | 25% elemental Au coated on a surface of a Pd |
| | substrate layer with one layer of MoS₂ catalyst coated |
| | on the Au layer |
| Pd-25Au-MoS₂-2 | 25% elemental Au atom coated on a surface of a Pd |
| | substrate layer with two layers of MoS₂ catalyst coated |
| | on the Au layer |

The hydrogen permeability of the prepared palladium (Pd)-based hydrogen-permeable membranes were conducted at a temperature of about 450° C. Pd-15Au has a hydrogen permeability (H₂ flux) of about 0.08 to 0.23 mol/m²s at a temperature of about 450° C. and under a pressure of about 0.7 to about 2.2 bar. Pd—MoS₂-1 showed a H₂ flux of about 0.03 to 0.24 mol/m²s at a temperature of about 450° C. and under a pressure of about 0.3 to about 3.9 bar. Pd-25Au-MoS₂-1 showed a H₂ flux of about 0.04 to 0.24 mol/m²s at a temperature of about 450° C. and under a pressure of about 0.3 to about 2.9 bar. Pd-25Au-MoS₂-2 showed a H₂ flux of about 0.04 to 0.24 mol/m²s at a temperature of about 450° C. and under a pressure of about 0.3 to about 3.4 bar. The results showed that the coated membrane retained its distinct ability to permeate hydrogen in the presence and/or absence of MoS₂ catalyst, as evident by the high flux results shown in FIG. 4.

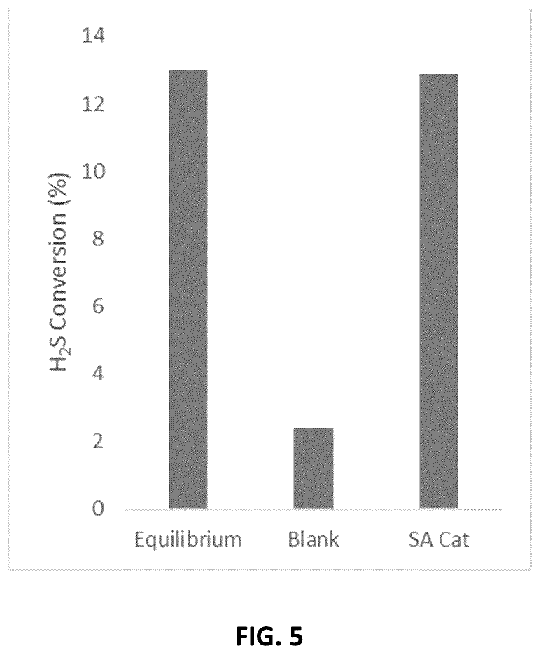

The H₂S splitting performance of the prepared palladium (Pd)-based hydrogen-permeable membranes were tested against both an empty reactor (in the absence of a hydrogen-permeable membrane) and the calculated thermodynamic equilibrium (the theoretical state of a H₂S splitting process). A feed gas stream containing approximately 2 vol. % of H₂S was introduced into the membrane reactor in contact with the Pd-based hydrogen-permeable membrane at a spacetime of 0.03 g s mL⁻¹ and a temperature of about 700° C. The results showed that the Pd-based hydrogen-permeable membrane had a H₂S conversion of about 11 to about 14 wt. % based on an initial H₂S concentration in the feed gas stream, as depicted in FIG. 5.

The present disclosure relates to a chemical process utilizing a membrane reactor to produce hydrogen (H₂) and sulfur (S) from hydrogen sulfide (H₂S). The membrane reactor includes a hydrogen-permeable membrane in a multi-layered structure containing a metallic layer, a protective layer disposed on the metallic layer, and one or more catalyst layers disposed on the protective layer. The protective layer and the one or more catalyst layers can be prepared from the same material. Each catalyst layer contains a H₂S decomposition catalyst that can split H₂S to generate H₂ and elemental sulfur vapor. The metallic layer of the hydrogen-permeable membrane allows hydrogen to permeate to the permeate side while rejecting unconverted H₂S and sulfur vapor. The sulfur vapor is then condensed into a condenser and recovered as liquid sulfur, while the H₂S can be recycled back to the membrane reactor. Thus, the membrane reactor can not only split H₂S to H₂ and sulfur vapor, but also separate H₂ and unconverted H₂S. Combining catalytic decomposition and separation in a single step overcomes thermodynamic limitations, resulting in higher hydrogen yields.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

Embodiment 1: A method for converting hydrogen sulfide (H₂S) to hydrogen (H₂) and sulfur (S), the method comprising:
introducing a H₂S-containing feed gas stream into one or more membrane reactors, wherein each of the one or more membrane reactors comprises a hydrogen-permeable membrane in a multi-layered structure comprising a metallic layer, a protective layer disposed on the metallic layer, and one or more catalyst layers disposed on the protective layer, wherein each of the one or more catalyst layers comprises a H₂S decomposition catalyst;
passing the H₂S-containing feed gas stream through the one or more membrane reactors to contact the H₂S-containing feed gas stream with the H₂S decomposition catalyst of the hydrogen-permeable membrane, thereby converting at least a portion of the H₂S to H₂ and S and producing a spent catalyst in-situ, a H₂ permeate gas stream, and a retentate gas stream, wherein the hydrogen-permeable membrane allows only H₂ to pass through in the formation of the H₂ permeate gas stream, and wherein the S is present in the retentate gas stream in the form of a vapor;
collecting the H₂ permeate gas stream; and
separating the S from the retentate gas stream by introducing the retentate gas stream into a condenser and cooling the retentate gas steam to a temperature of about 110 to about 400° C., thereby generating the S in a liquid form and a H₂S-containing recycle gas stream leaving the condenser.
   Embodiment 2: The method of embodiment 1, wherein the H₂S is present in the H₂S-containing feed gas stream at a concentration of about 20 to about 95 volume percentage (vol. %) based on a total volume of the H₂S-containing feed gas stream.
   Embodiment 3: The method of embodiment 1 or 2, wherein the H₂S-containing feed gas stream further comprises one or more gases selected from the group consisting of carbon dioxide (CO₂), water (H₂O), ammonia (NH₃), methane (CH₄), carbon disulfide (CS₂), carbonyl sulfide (COS), benzene, toluene, and xylene.
   Embodiment 4: The method of any one of embodiments 1-3, wherein the H₂S is present in the retentate gas stream at a concentration of less than about 10 vol. % based on a total volume of the retentate gas stream.
   Embodiment 5: The method of any one of embodiments 1-4, wherein the H₂S-containing feed gas stream is passed through the membrane reactor under pressure of about 5 to about 20 atmospheric pressure (atm).
   Embodiment 6: The method of any one of embodiments 1-5, wherein the H₂S-containing feed gas stream is passed through the membrane reactor at a temperature of about 450 to about 800° C.
   Embodiment 7: The method of any one of embodiments 1-6, wherein the H₂S-containing feed gas stream is introduced into two or more membrane reactors, and the two or more membrane reactors are arranged in parallel with each other.
   Embodiment 8: The method of any one of embodiments 1-7, wherein the H₂S-containing feed gas stream is introduced into two or more membrane reactors, and the two or more membrane reactors are arranged in series with each other.
   Embodiment 9: The method of any one of embodiments 1-8, wherein each of the one or more membrane reactors is in the form of a horizontal tubular reactor comprising:
two gas inlets;
two retentate gas outlets;
one H₂ permeate gas outlet;
two hydrogen-permeable membranes located within a body portion of the horizontal tubular reactor and separated by a H₂ permeate gas chamber, wherein the H₂ permeate gas chamber is coaxially disposed within the horizontal tubular reactor, and is in in fluid communication with the H₂ permeate gas outlet; and
two retentate gas chambers, wherein each of the two retentate gas chambers comprises a first end and a second end opposite to the first end, wherein one of the two gas inlets is disposed on the first end of the retentate gas chamber, and one of the two gas outlets is disposed on the second end of the same retentate gas chamber.
   Embodiment 10: The method of any one of embodiments 1-9, wherein the one or more catalyst layers of each of the two hydrogen-permeable membranes are in direct contact with each of the two corresponding retentate gas chambers.
   Embodiment 11: The method of any one of embodiments 1-10, wherein the metallic layer of each of the two hydrogen-permeable membranes is in direct contact with the H₂ permeate gas chamber.
   Embodiment 12: The method of any one of embodiments 1-8, wherein each of the one or more membrane reactors is in the form of a packed bed membrane reactor comprising: one gas inlet;
one retentate gas outlet;
two H₂ permeate gas outlets;
two hydrogen-permeable membranes located within a body portion of the packed bed membrane reactor and separated by a H₂S decomposition catalyst bed, wherein the H₂S decomposition catalyst bed is coaxially located within the packed bed membrane reactor, a first end of the H₂S decomposition catalyst bed is in in fluid communication with the gas inlet, and a second end of the H₂S decomposition catalyst bed is in in fluid communication with the retentate gas outlet; and
two H₂ permeate gas chambers, wherein each of the two H₂ permeate gas chambers comprises a first end and a second end opposite to the first end, wherein one of the two H₂ permeate gas outlets is disposed on the second end of the corresponding H₂ permeate gas chamber.
   Embodiment 13: The method of any one of embodiments 1-8 and 12, wherein the one or more catalyst layers of each of the two hydrogen-permeable membranes are in direct contact with the H₂S decomposition catalyst bed.
   Embodiment 14: The method of any one of embodiments 1-8 and 12-13, wherein the metallic layer of each of the two hydrogen-permeable membranes is in direct contact with each of the two corresponding H₂ permeate gas chambers.
   Embodiment 15: The method of any one of embodiments 1-14, wherein the metallic layer of the hydrogen-permeable membrane comprises palladium, vanadium, niobium, tantalum, or a mixture thereof in combination with one or more of copper, gold, platinum, indium, ruthenium as binary, ternary, or quaternary alloys.
   Embodiment 16: The method of any one of embodiments 1-15, wherein the protective layer of the hydrogen-permeable membrane comprises a metal carbide or a metal sulfide.
   Embodiment 17: The method of any one of embodiments 1-16, wherein the protective layer comprises a metal carbide selected from the group consisting of chromium carbide, molybdenum carbide, niobium carbide, tantalum carbide, titanium carbide, tungsten carbide, vanadium carbide, and combinations thereof.
   Embodiment 18: The method of any one of embodiments 1-17, wherein the H₂S decomposition catalyst of each of the one or more catalyst layers comprises a metal sulfide or a bimetallic alloy.
   Embodiment 19: The method of any one of embodiments 1-18, wherein the H₂S decomposition catalyst comprises a metal sulfide selected from the group consisting of molybdenum disulfide, iron sulfide, and combinations thereof.
   Embodiment 20: The method of any one of embodiments 1-19, wherein the H₂S decomposition catalyst is molybdenum disulfide in the form of a flower-like nanosheet microsphere having an average particle size of about 400 to about 1000 nanometers (nm).
   Embodiment 21: The method of any one of embodiments 1-20, further comprising preparing the hydrogen-permeable membrane by one or more techniques selected from the group consisting of electroplating, electroless plating, physical vapor deposition (PVD), chemical vapor deposition (CVD), atomic layer deposition (ALD), catalyst impregnation, modulated pulsed power magnetron sputtering (MPPMS), and high-power pulsed magnetron sputtering (HPPMS).

1. A method for converting hydrogen sulfide (H₂S) to hydrogen (H₂) and sulfur (S), the method comprising:
introducing a H₂S-containing feed gas stream into one or more membrane reactors, wherein each of the one or more membrane reactors comprises a hydrogen-permeable membrane in a multi-layered structure comprising a metallic layer, a protective layer disposed on the metallic layer, and one or more catalyst layers disposed on the protective layer, wherein each of the one or more catalyst layers comprises a H₂S decomposition catalyst;
passing the H₂S-containing feed gas stream through the one or more membrane reactors to contact the H₂S-containing feed gas stream with the H₂S decomposition catalyst of the hydrogen-permeable membrane, thereby converting at least a portion of the H₂S to H₂ and S and producing a spent catalyst in-situ, a H₂ permeate gas stream, and a retentate gas stream, wherein the hydrogen-permeable membrane allows only H₂ to pass through in the formation of the H₂ permeate gas stream, and wherein the S is present in the retentate gas stream in the form of a vapor;
collecting the H₂ permeate gas stream; and
separating the S from the retentate gas stream by introducing the retentate gas stream into a condenser and cooling the retentate gas steam to a temperature of about 110 to about 400° C., thereby generating the S in a liquid form and a H₂S-containing recycle gas stream leaving the condenser.

2. The method of claim 1, wherein the H₂S is present in the H₂S-containing feed gas stream at a concentration of about 20 to about 95 volume percentage (vol. %) based on a total volume of the H₂S-containing feed gas stream.

3. The method of claim 1, wherein the H₂S-containing feed gas stream further comprises one or more gases selected from the group consisting of carbon dioxide (CO₂), water (H₂O), ammonia (NH₃), methane (CH₄), carbon disulfide (CS₂), carbonyl sulfide (COS), benzene, toluene, and xylene.

4. The method of claim 1, wherein the H₂S is present in the retentate gas stream at a concentration of less than about 10 vol. % based on a total volume of the retentate gas stream.

5. The method of claim 1, wherein the H₂S-containing feed gas stream is passed through the membrane reactor under pressure of about 5 to about 20 atmospheric pressure (atm).

6. The method of claim 1, wherein the H₂S-containing feed gas stream is passed through the membrane reactor at a temperature of about 450 to about 800° C.

7. The method of claim 1, wherein the H₂S-containing feed gas stream is introduced into two or more membrane reactors, and the two or more membrane reactors are arranged in parallel with each other.

8. The method of claim 1, wherein the H₂S-containing feed gas stream is introduced into two or more membrane reactors, and the two or more membrane reactors are arranged in series with each other.

9. The method of claim 1, wherein each of the one or more membrane reactors is in the form of a horizontal tubular reactor comprising:
two gas inlets;
two retentate gas outlets;
one H₂ permeate gas outlet;
two hydrogen-permeable membranes located within a body portion of the horizontal tubular reactor and separated by a H₂ permeate gas chamber, wherein the H₂ permeate gas chamber is coaxially disposed within the horizontal tubular reactor, and is in in fluid communication with the H₂ permeate gas outlet; and
two retentate gas chambers, wherein each of the two retentate gas chambers comprises a first end and a second end opposite to the first end, wherein one of the two gas inlets is disposed on the first end of the retentate gas chamber, and one of the two gas outlets is disposed on the second end of the same retentate gas chamber.

10. The method of claim 9, wherein the one or more catalyst layers of each of the two hydrogen-permeable membranes are in direct contact with each of the two corresponding retentate gas chambers.

11. The method of claim 9, wherein the metallic layer of each of the two hydrogen-permeable membranes is in direct contact with the H₂ permeate gas chamber.

12. The method of claim 1, wherein each of the one or more membrane reactors is in the form of a packed bed membrane reactor comprising:
one gas inlet;
one retentate gas outlet;
two H₂ permeate gas outlets;
two hydrogen-permeable membranes located within a body portion of the packed bed membrane reactor and separated by a H₂S decomposition catalyst bed, wherein the H₂S decomposition catalyst bed is coaxially located within the packed bed membrane reactor, a first end of the H₂S decomposition catalyst bed is in in fluid communication with the gas inlet, and a second end of the H₂S decomposition catalyst bed is in in fluid communication with the retentate gas outlet; and
two H₂ permeate gas chambers, wherein each of the two H₂ permeate gas chambers comprises a first end and a second end opposite to the first end, wherein one of the two H₂ permeate gas outlets is disposed on the second end of the corresponding H₂ permeate gas chamber.

13. The method of claim 12, wherein the one or more catalyst layers of each of the two hydrogen-permeable membranes are in direct contact with the H₂S decomposition catalyst bed.

14. The method of claim 12, wherein the metallic layer of each of the two hydrogen-permeable membranes is in direct contact with each of the two corresponding H₂ permeate gas chambers.

15. The method of claim 1, wherein the metallic layer of the hydrogen-permeable membrane comprises palladium, vanadium, niobium, tantalum, or a mixture thereof in combination with one or more of copper, gold, platinum, indium, ruthenium as binary, ternary, or quaternary alloys.

16. The method of claim 1, wherein the protective layer of the hydrogen-permeable membrane comprises a metal carbide or a metal sulfide.

17. The method of claim 16, wherein the protective layer comprises a metal carbide selected from the group consisting of chromium carbide, molybdenum carbide, niobium carbide, tantalum carbide, titanium carbide, tungsten carbide, vanadium carbide, and combinations thereof.

18. The method of claim 1, wherein the H₂S decomposition catalyst of each of the one or more catalyst layers comprises a metal sulfide or a bimetallic alloy.

19. The method of claim 18, wherein the H₂S decomposition catalyst comprises a metal sulfide selected from the group consisting of molybdenum disulfide, iron sulfide, and combinations thereof.

20. The method of claim 18, wherein the H₂S decomposition catalyst is molybdenum disulfide in the form of a flower-like nanosheet microsphere having an average particle size of about 400 to about 1000 nanometers (nm).

21. The method of claim 1, further comprising preparing the hydrogen-permeable membrane by one or more techniques selected from the group consisting of electroplating, electroless plating, physical vapor deposition (PVD), chemical vapor deposition (CVD), atomic layer deposition (ALD), catalyst impregnation, modulated pulsed power magnetron sputtering (MPPMS), and high-power pulsed magnetron sputtering (HPPMS).
